(19) United States
(12) Patent Application Publication
(10) Pub. No.: US 2003/0227104 A1
(43) Pub. Date: Dec. 11, 2003

(54) Core for winding material and method for manufacturing the same

(76) Inventor: Mark J. Majeski, Norton, WV (US)

Correspondence Address: TROUTMAN SANDERS LLP, BANK OF AMERICA PLAZA, SUITE 5200, 600 PEACHTREE STREET , NE, ATLANTA, GA, 30308-2216, US

(21) Appl. No.: 10/163,865

(22) Filed: Jun. 5, 2002

(51) Int. Cl. B29C 43/02

(52) U.S. Cl. 264/159; 264/322; 156/304.2; 492/59; 242/364

(57) ABSTRACT

A core for winding a continuous web of material. In one embodiment of the present invention, the core includes a first inner portion and a second outer portion. The inner and outer portions once had the same inner diameters. However, the outer portion is resized to having a second inner diameter so that it may overlap the first inner portion. A workpiece, which will be cut into a plurality of second outer portions, is heated. The heated workpiece is then placed over a plug which has an outer diameter that substantially corresponds to the desired inner diameter for the second outer portions. By placing the heated workpiece over the plug, the workpiece is stretched to have the desired second inner diameter. The workpiece is then cut into a plurality of second outer portions of the desired width. Because the inner diameter of each second portion is now larger, they are permitted to overlap a corresponding first inner portion.

### RELATED APPLICATIONS

The application titled “GANG SAW SYSTEM FOR ROTATING AND SEGEMENTING A WORKPIECE”, having been filed concurrently with the present application, is hereby incorporated herein by reference.

### TECHNICAL FIELD

The present invention relates to the winding of narrow width and thin gage ribbons of material such as aluminum and, more particularly, relates to the manufacture of the core upon which such materials are wound.

### BACKGROUND OF THE INVENTION

The use of a core is widely used in many industries for the winding and unwinding of materials. A goal in each industry is to utilize a cost effective core in the manufacturing process. Also, each industry desires to utilize a core which has structural characteristics suitable for the particular material to be wound or unwound. Some materials require that the core, upon which it is wound, to have particular dimensional requirements as well as strength requirements. Moreover, some industries require that their cores not only be reusable, but be manufactured from readily available materials for cost effectiveness.

For example, aluminum producers typically require aluminum of a particular gauge and width be wound on a cardboard core. Although cardboard is cost effective to use, problems often occur which degrade the structural integrity of cardboard cores. One such problem is that cardboard cores are prone to shrinkage as a result of the changing moisture content in the cores. Another problem is that cardboard cores sometimes collapse because of insufficient strength. In response, some industries have attempted to utilize machined steel cores; but this is cost prohibitive. Moreover, the use of steel cores does not provided the desired dimensional requirements needed in most industries that utilizing some sort of winding or unwinding apparatus.

The cores upon which most materials are wound are typically circular with a hollow interior. Some industries require that the width and inner diameter of these cores have a particular dimension in order for the cores to be suitable for use with their winding or unwinding machines. However, manufacturing a core having the desired inner diameter, while utilizing readily available and cost effective materials, has proven difficult.

PVC (polyvinyl chloride) or some other thermoplastic resin, for example, is readily available and cost effective to use. PVC is typically manufactured in the form of elongated pipe of varying sizes. However, despite having available a wide range of PVC pipe, PVC pipe is not always available with the particular inner diameters need to permit use in common winding and unwinding machines. The inner diameter may be slightly narrower than desired. Also, the inner and outer diameters of common extruded PVC pipe are often irregular which makes ensuring uniformity difficult when placing a plurality of cores on an arbor of a winding machine. Moreover, when utilizing a PVC core, the PVC core often flexes during winding due to its thin walls. Therefore, in order to use a readily available material such as PVC to manufacture cores for winding and unwinding of a continuous web of material, the core may not only require resizing to permit its use on commonly available winding and unwinding machines, but the core may also require reinforcement in order to have the structural integrity needed to prevent flexing.

Therefore, there is a need for an improved core manufactured from a readily available and cost effective material. The new core must be able to maintain its structural integrity, even when placed under significant loads, while also being easily modifiable to permit being reconfigured to have particular dimensional requirements.

### SUMMARY OF THE INVENTION

The present invention solves the above-identified problem by providing an improved core for winding a continuous web of material from readily available and cost effective materials. The core of the present invention may be resized to have the particular inner diameter required for use with common winding machines or may be modified to double its thickness to provide increased structural integrity.

Generally described, the present invention includes a rigid core for winding of material. The core has been reconfigured from once having a first inner diameter into having a second inner diameter. The core has been reconfigured by heating the core when having the first diameter and then stretching the heated core to then have the second inner diameter. As a result of resizing the core to have the second inner diameter, the core may be utilized in a winding machine for winding a continuous web of material.

According to one aspect of the invention, the core includes an first inner portion and a second outer portion. The second outer portion overlaps the exterior of the first portion. Either of the first inner portion and the second outer portion, or both, is reconfigured from once having a first inner diameter into having a second inner diameter by heating and stretching such that the second portion overlaps the exterior of the first portion and the resulting core is sized for use in a winding machine.

The foregoing has broadly outlined some of the more pertinent aspects and features of the present invention. These should be construed to be merely illustrative of some of the more prominent features and applications of the invention. Other beneficial results can be obtained by applying the disclosed information in a different manner or by modifying the disclosed embodiments. Accordingly, other aspects and a more comprehensive understanding of the invention may be obtained by referring to the detailed description of the exemplary embodiments taken in conjunction with the accompanying drawings, in addition to the scope of the invention defined by the claims.

### BRIEF DESCRIPTION OF THE DRAWINGS

FIG. 1 illustrates a perspective view of one embodiment of a core of the present invention.

FIG. 2 illustrates a front view of the core of FIG. 1.

FIG. 3 illustrates an exploded view of the core of FIG. 1.

FIG. 4 illustrates the core of FIG. 1 wherein the inner and outer portions of the core are partially separated from one another.

FIG. 5 illustrates one embodiment of a plug for resizing a core.

FIG. 6 illustrates an alternative embodiment of a plug for resizing a core.

FIG. 7 illustrates a portion of a workpiece being placed over the plug of FIG. 5.

FIG. 8 illustrates the portion of the workpiece received on the plug and stretched to have an inner diameter that corresponds with the outer diameter of the plug.

FIG. 9 illustrates a plurality of cores made from the resized workpiece of FIG. 8.

FIG. 10 illustrates a perspective view of an alternative embodiment of a core of the present invention.

### DETAILED DESCRIPTION

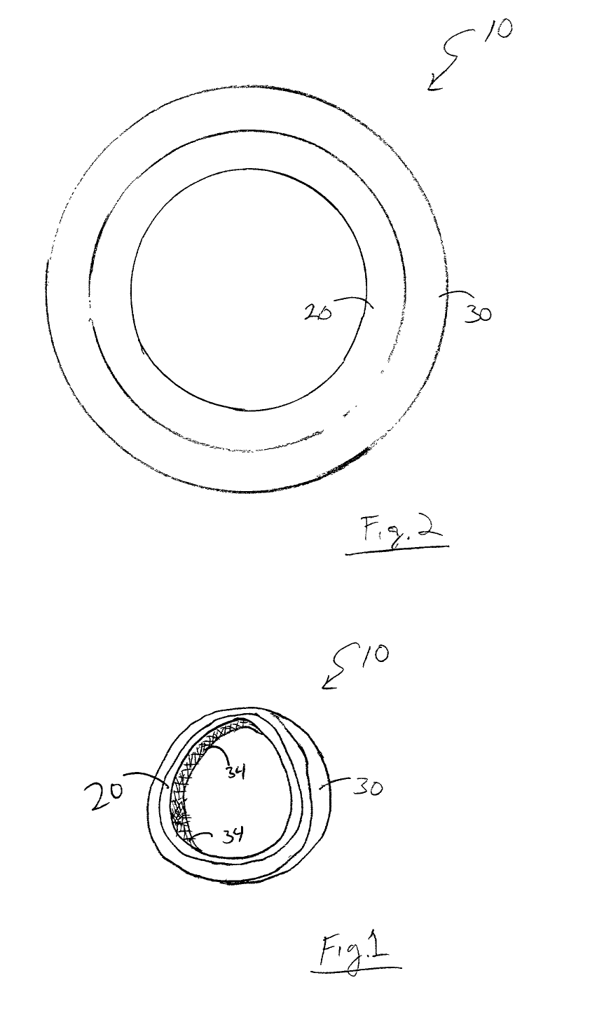

Referring now to the drawings in which like numerals indicate like elements throughout the several views, FIGS. 1 and 2 illustrate an exemplary embodiment of a core 10, often referred to as a double core 10, for receiving a continuous web of material. The core 10 may be used by a winding machine (not shown) to wind a continuous web of material such as aluminum.

Also, although the embodiments described herein are primarily directed toward the use of PVC or some other thermoplastic resin to manufacture the core 10, the present invention contemplates the use of workpieces of any type of material which may be segmented into cores for winding a continuous web of material. The workpiece is typically cylindrical with a hollow center there through. Preferably, the workpiece is hollow PVC piping which may be cut into annular pieces. However, the workpiece may have any possible configuration suitable for being segmented into a plurality of cores 10 for receiving a continuous web of material.

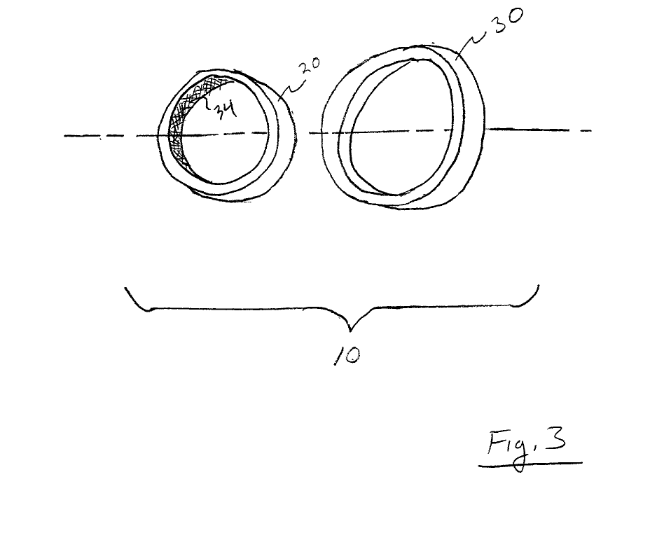

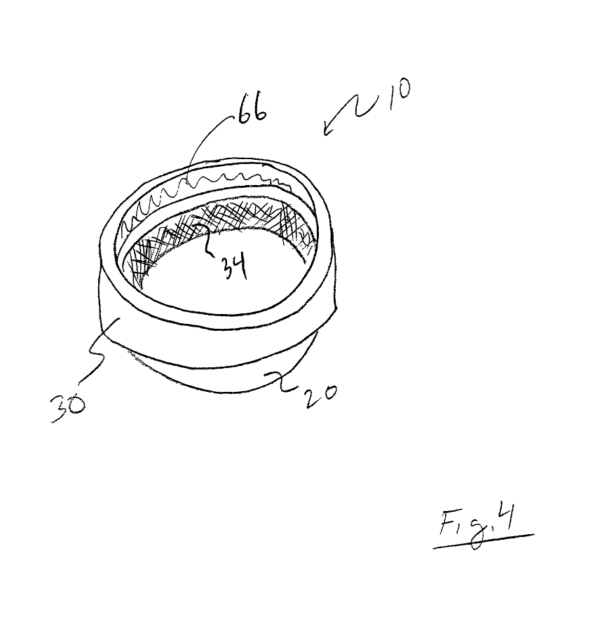

As best shown in FIG. 3, one embodiment of the core 10 of the present invention includes a first inner portion 20 and a second outer portion 30. The core 10 is commonly referred to as a double core 10, as mentioned above, because it includes both the first inner portion 20 and the second outer portion 30. Preferably, the first inner and second outer portions 20, 30 are made from plastic such as PVC. Moreover, the first inner and second outer portions 20, 30 may be made from the same portion of PVC piping. Because the core 10 includes both the first inner portion 20 and the second outer portion 30, the thickness of the core 10 has been doubled. The increased thickness provides greater structural integrity to the core 10 which eliminates the problem with flexing as described above.

Preferably, the inner exposed surface of the first inner portion 20 has been roughed to provide a fraction bearing surface for users when transporting the cores 10. The roughed surface 34 is generally shown in FIGS. 1, 3 and 4. The roughed surface 34 may be created by hand using any available grinding apparatus.

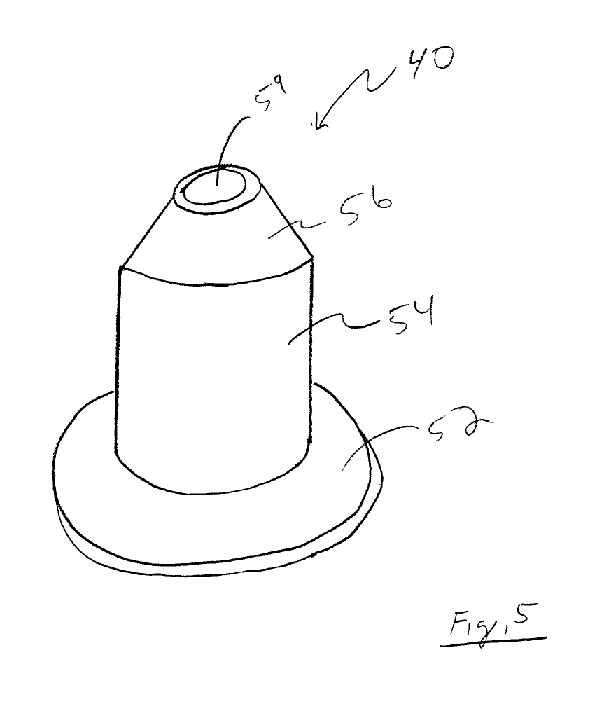

A plurality of cores 10 may be manufactures from an elongated length of PVC piping. For example, a plurality of workpieces 60 may be cut from a single length of PVC piping and a plurality of first inner portions 20 and second outer portions 30 may then be made from the workpieces 60. As explained above, in each core 10, the outer portion 30 overlaps the exterior of the inner portion 20. If the inner diameter of the inner portion 20 corresponds with the an inner diameter needed to permit use on a winding machine, no stretching is required and at least one of the workpieces 60 may be cut into a plurality of first inner portions 20 of the desired width. However, the inner diameter of the second outer portion 30 must then be resized such that it may be placed over the first inner portion 20 as shown in FIGS. 3 and 4. Resizing of a workpiece 60 to make a plurality of second outer portions 30 is explained in greater detail below.

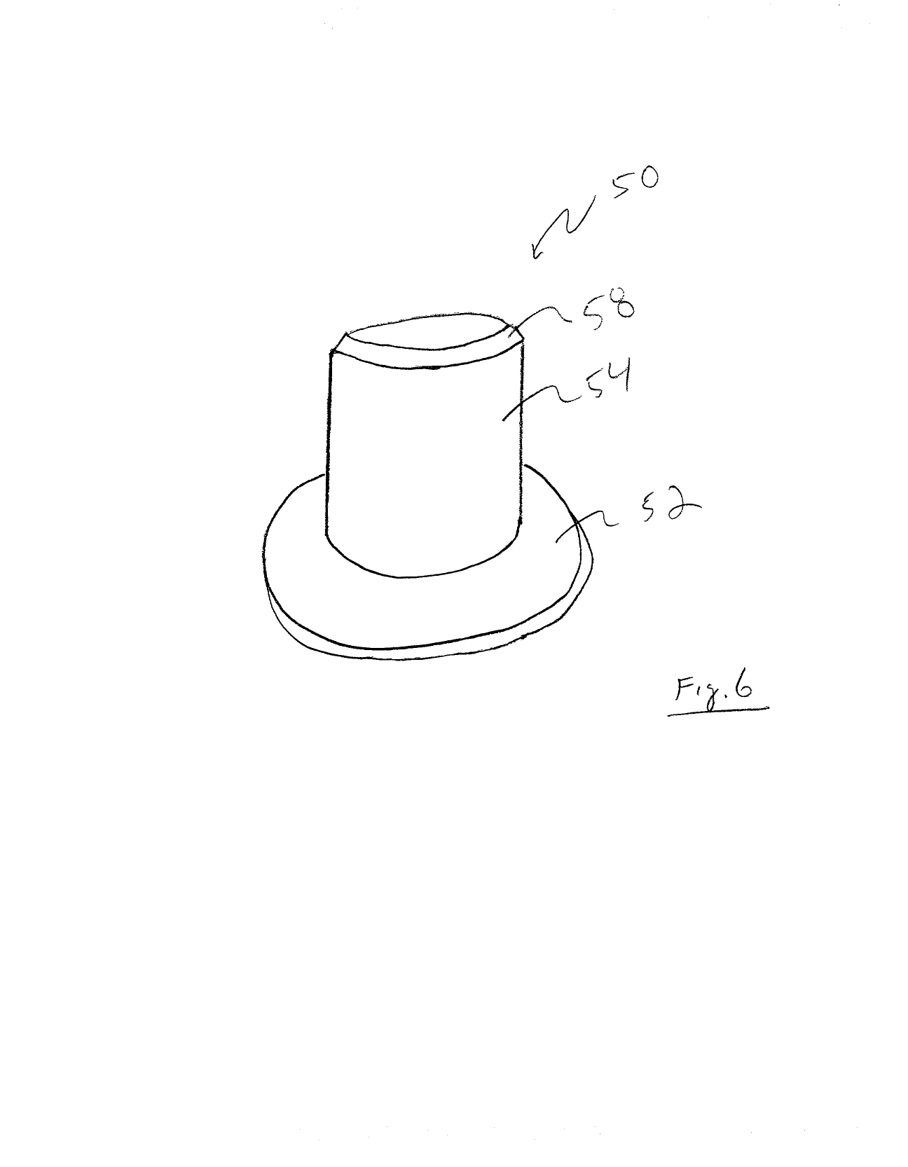

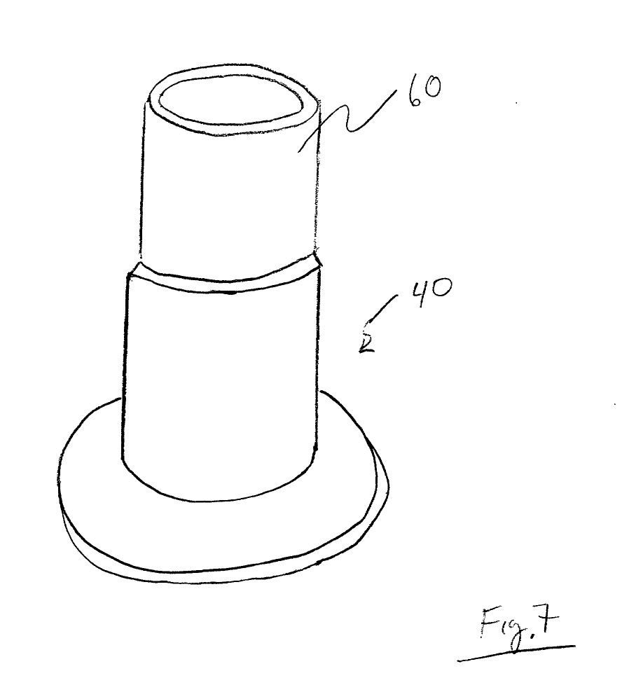

FIG. 5 illustrates one embodiment of a plug 40 utilized in the resizing process. FIG. 6 illustrates an alternative embodiment of a plug 50. In either case, the plugs 40, 50 are preferably aluminum and include a base 52 from which an elongated portion 54 extends upward. On top of the elongated portions 54 of the plugs 40 and 50 is a tapered nose portion 56 and 58, respectively. The elongated portions 54 of each plug 40, 50 have different outer diameters and are primarily distinguishable based upon the height of each tapered nose portion 56, 58. The taper is longer on plug 40 because of the larger amount of plastic it is capable of stretching. The plug 40 also includes an opening 59 which passes through the length of the elongated portion 54.

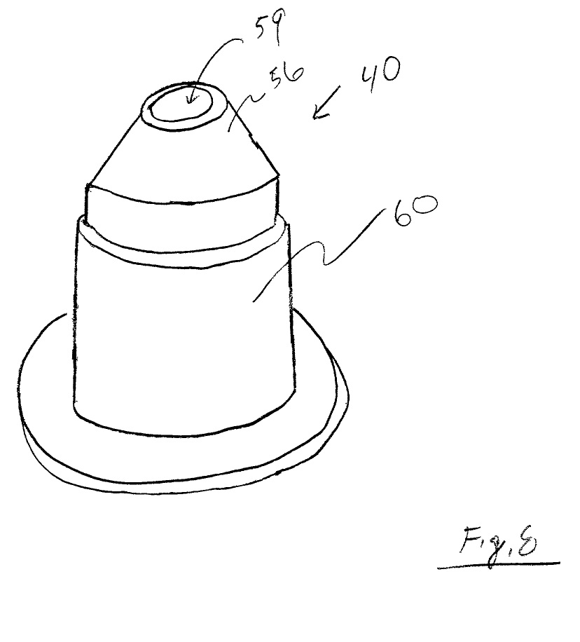

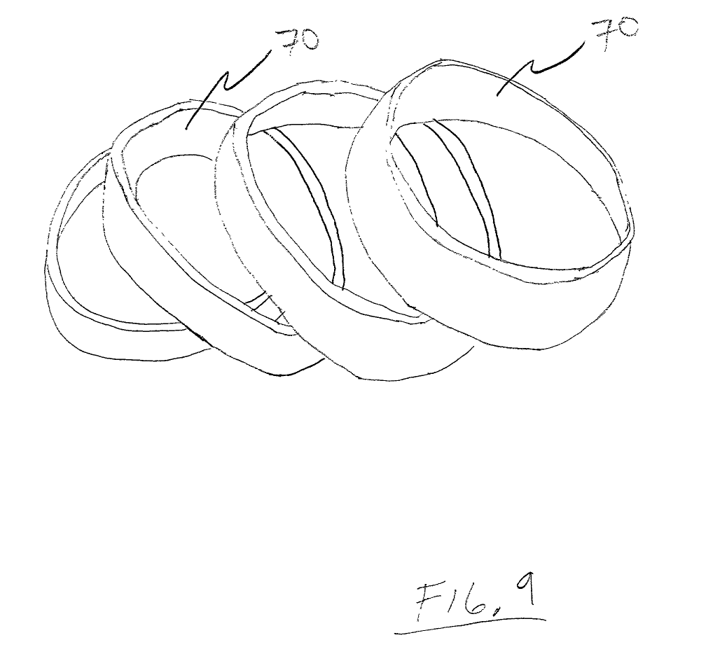

The elongated portion 54 of each plug 40, 50 preferably is configured to receive a heated workpiece 60, such as PVC, over its exterior as shown in FIGS. 7 and 8. The PVC workpiece 60 should be heated in an oven to approximately 260 to 330 degrees Fahrenheit. Preferably, the PVC workpiece 60 is heated to approximately 320 degrees Fahrenheit. Heating PVC to a temperature less than 260 degrees Fahrenheit may not have enough of an effect on the workpiece 60 to allow the workpiece 60 to be completely placed over the elongated portions 54 of the plugs 40, 50 and stretched as particularly shown in FIG. 8. Also, heating the workpiece 60 to a temperature beyond 330 degrees Fahrenheit can create a burnt appearance in the PVC workpiece 60.

The elongated portion 54 of the plug 40 is preferably circular and has an outer diameter which is slightly larger than the desired inner diameter for each of the second outer portions 30 being manufactured. The diameter of the elongated portions 54 of the plugs 40, 50 must account for shrinkage of the workpiece 60 after cooling. For example, when stretching a workpiece 60 from having a 6.040 inch inner diameter to having a 6.625 inner diameter, the elongated portion 54 of the plug 40 has to have an outer diameter of approximately 6.675 inches. The outer diameter of the elongated portion 54 of the plug 40 is approximately 0.050 inches larger to account for shrinkage of the workpiece 60 after cooling.

In other examples, workpieces from commonly available PVC piping with inner diameters of 9.800 and 12.075 inches have been stretched to have inner diameters of approximately 10.020 and 12.100 inches, respectively. Separate plugs with the appropriate outer diameter should be used to stretch these larger workpieces. For example, a plug having an outer diameter of approximately 12.125 inches is needed for stretching PVC to 12.100 inches with shrinkage.

After resizing the workpiece 60, the workpiece 60 will be cut to the appropriate widths to make a plurality of second outer portions 30. Thus, the inner diameter of the second outer portions 30 now substantially correspond with the outer diameter of the first inner portion 20 such that each second outer portion 30 overlaps the exterior of a corresponding first inner portion 20. The first inner and second outer portions 20, 30 may be friction fitted together or, preferably, adhesively bonded together with any suitable adhesive 66 typically used in PVC applications. Each pair of corresponding first inner and second outer portions 20, 30 are concentric with one another to define a double core 10 capable of being used in a winding machine. The outer diameter of each of the second outer portions 30 should be substantially similar to each other so that multiple cores 10 may be simultaneously lined up in a winding machine to wind a continuous web of material. The double cores 10 are rotated by the winding machine in order to accumulate the continuous web of material onto each double core 10.

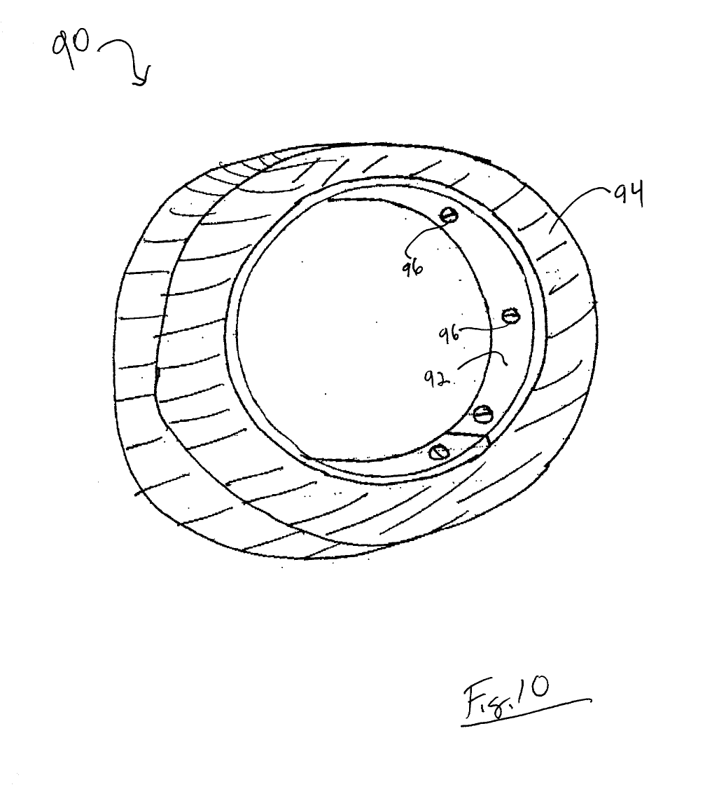

In an alternative embodiment, a workpiece may be stretched to increase its inner diameter by using the plug 50 shown in FIG. 6. In such case, the workpiece would then be cut into a plurality of annular portions 70 as shown in FIG. 9. Each annular portion 70 would then itself define a core 70 for winding a continuous web of material. Preferably, the cores 70 are used for winding and transportation of lighter materials compared to the materials wound and transported by the cores 10 described above. Also, the cores 70 are preferably made from PVC or some other thermoplastic resin.

The plug 50 is preferably used to stretch a workpiece approximately 0.100 inches. However, when using the plug 50, the workpiece need not be heated as much as earlier described because the workpiece is not being stretched as much. For example, if plug 50 has an outer diameter of approximately 6.075 inches, the workpiece heated to approximately 280 degrees Fahrenheit may then be stretched from having an inner diameter of approximately 5.940 inches to having an inner diameter of approximately 6.040 inches. After cooling, the workpiece stretched by plug 50 may then be cut into a plurality of cores 70 for winding a continuous web of material. Preferably, each core 70 includes an exposed roughed surface similar to the roughed surface 66 described above.

FIG. 10 illustrates an alternative embodiment of the present invention. A core 90 includes an inner ring 92, preferably made of steel, and an outer portion 94, preferably made of PVC. The steel inner ring 92 is preferably made from flat stock steel cut into ⅛ inch thick by 1 inch wide elongated portions, which are then rolled into a ring. The outer portion 94 is sized to have the desired inner dimensions by heating and stretching as described above. The rolled inner ring 92 is then squeezed into the outer portion 94. Preferably, when the steel is rolled to form the ring 92, a gap is formed between the ends of the elongated portion so that the inner ring 92 may be squeezed together, to reduce its diameter, so that it will fit within the outer portion 94. In FIG. 10, however, there is no gap shown because the ends of the inner ring 92 have already been squeezed together. The spring action of the inner ring 92, because of the outward bias of the squeezed together ring 92, will then force the inner ring 92 and outer portion 94 to remain together to form the core 90. In addition, holes may be drilled into the portions of steel, before forming the rings, so that recessed screws 96 may be used to secure each inner ring 92 to the inside of an outer portion 94.

The manufacture of the core 10, described above, constitutes an inventive method of the present invention in addition to the core 10 itself. In practicing the method of manufacturing a core 10, the steps include providing first and second annular portions 20, 30 having a first inner diameter. The method then includes heating the second annular portion 30. Next, the method includes stretching the second annular portion with an annular plug 40, as described above, such that the second annular portion has a second inner diameter. The method then includes the step of overlapping the exterior of the first annular portion with the second annular portions to define the core 10.

The method of may also include the steps of cooling the second annular portion and adhesively bonding the first and second annular portions together.

The present invention has been illustrated in relation to particular embodiments which are intended in all respects to be illustrative rather than restrictive. Those skilled in the art will recognize that the present invention is capable of many modifications and variations without departing from the scope of the invention. Accordingly, the scope of the present invention is described by the claims appended hereto and supported by the foregoing.

What is claimed is:

1. A core for winding of material, said core having been reconfigured from once having a first inner diameter into having a second inner diameter by heating the core when having said first diameter and then stretching said core to then have said second inner diameter, wherein said second inner diameter is larger than said first diameter and said core may be utilized for winding of material.

2. The core of claim 1 wherein said core is made of plastic.

3. The core of claim 1 wherein said core is made of PVC.

4. The core of claim 1 wherein at least a portion of the exposed inner surface of said core includes a roughed surface.

5. A core for winding and unwinding of material, said core comprising a first inner portion and an second outer portion, said second outer portion overlapping the exterior of said first inner portion to define said core, both said first inner portion and said second outer portion having a first inner diameter, said second outer portion having been reconfigured from having had said first inner diameter into having a second inner diameter by heating said second outer portion when having said first diameter and then stretching said second outer portion to have said second inner diameter, wherein said second inner diameter is larger than said first diameter and wherein said second outer portion is permit to overlap said first inner portion.

6. The core of claim 5 wherein said first and second portions are concentric with one another.

7. The core of claim 5 wherein said first and second portions are made from plastic.

8. The core of claim 5 wherein said first and second portions are made from PVC.

9. The core of claim 5 wherein said first and second portions have been cut from the same workpiece.

10. The core of claim 5 wherein at least a portion of an exposed inner surface of said first portion includes a roughed surface.

11. The core of claim 5 further comprising an adhesive between said first and second portion for securing each said first and second portions together.

12. A method for manufacturing a core for winding a continuous web of material, said method comprising the steps of:
providing an annular portion having a first inner diameter;
heating said annular portion; and
stretching said annular portion with an annular plug such that said annular portion has a second inner diameter, wherein said second inner diameter is larger than said first inner diameter.

13. A method for manufacturing a core for winding a continuous web of material, said method comprising the steps of:
providing first and second annular portions having a first inner diameter;
heating said second annular portion;
stretching said second annular portion with an annular plug such that said second annular portion has a second inner diameter, said second inner diameter being larger than said first inner diameter; and
overlapping the exterior of said first annular portion with said second annular portion to define said core.

14. The method of claim 13 further comprising the step of cooling said second annular portion.

15. The method of claim 13 further comprising the step of segmenting a workpiece into a plurality of portions defining said first and second annular portions wherein each said plurality of portions has the same desired width.

16. The method of claim 13 further comprising the step of rotating said core in order to accumulate said continuous web of material onto said core.

17. The method of claim 13 further comprising the step of adhesively bonding said first and second annular portions together.

18. A core manufactured by the process of claim 13.

19. A core for winding of material, comprising an outer portion having been resized from having had a first inner diameter to have a second inner diameter, and an inner ring formed from an elongated portion of material rolled into a ring and configured to be received and retained within the outer portion.

20. The core of claim 19 wherein the ring is biased outward so that the ring is retained within the outer portion.

21. The core of claim 19 further comprising a plurality of screws wherein the ring and outer portion are secured together.
